(19) United States
(12) Patent Application Publication
(10) Pub. No.: US 2022/0333881 A1
(43) Pub. Date: Oct. 20, 2022

(54) HORIZONTAL COLLECTING-WHILE-SENDING-BALL WATER SEPARATOR

(71) Applicant: SHENZHEN HANDFOS FLUID MECHANICAL & ELECTRICAL EQUIPMENT CO.,LTD, Shenzhen,Guangdong (CN)

(72) Inventor: Yonggang NI, Shenzhen, Guangdong (CN)

(21) Appl. No.: 17/633,114

(22) PCT Filed: Sep. 20, 2019
(86) PCT No.: PCT/CN2019/107116

§ 371 Date: Feb. 4, 2022

(51) Int. Cl. F28G 1/12; F28G 15/00

(52) U.S. Cl. CPC F28G 1/12; F28G 15/00

(57) ABSTRACT

A horizontal collecting-while-sending-ball water separator, has an outer barrel, the side wall of the outer barrel has a ball collection opening, a water outlet, a ball sending opening and a water inlet; a water inlet and outlet control valve connects to the water outlet and the water inlet, the control valve comprises an inner barrel, the inner barrel is divided into a first conduit and a second conduit, the side wall of the first conduit has two first openings, the side wall of the second conduit has two second openings; the separator can collect and send balls synchronously.

### CROSS-REFERENCE TO RELATED APPLICATIONS

This application is the national stage of International Application No. PCT/CN2019/107116 filed Sep. 20, 2019, the entire contents of which are incorporated herein by reference.

### TECHNICAL FIELD

The present disclosure relates to the field of rubber balls cleaning, especially a horizontal collecting-while-sending-ball water separator.

### BACKGROUND OF THE INVENTION

It is usual to use rubber balls to clean condensers or air conditioning units, but collecting and sending balls processes are necessary when cleaning, so it is also necessary to use a ball-water-separator to separate balls and water to recycle balls. It is common for ball-water-separators in market to send balls firstly and receive late, the method of sending all balls firstly and collecting balls late leads to a low balls collecting efficiency because some balls are trapped by balls collecting net of a ball collecting machine.

### SUMMARY OF THE INVENTION

The present disclosure provides a horizontal collecting-while-sending-ball water separator to solve above problems, the separator can collect and send balls synchronously, not only does this result in a higher collecting efficiency that consumes less power, but also allows the structure of the separator to be more simple and reliable and easy to make. The separator is appropriate for end-covered cleaning machines, double-return-pipe cleaning machines and single-return-pipe cleaning machines.

The technical solution provided by the present disclosure is:

A horizontal collecting-while-sending-ball water separator comprises an outer barrel, on one side wall of the outer barrel is provided with a ball collection opening and a water outlet, and the other side wall of the outer barrel is provided with a ball sending opening and a water inlet; Both the water outlet and the water inlet are connected with a water inlet and outlet control valve for turning on and off of water, and the control valve comprises an inner barrel configured inside the outer barrel, and the inner space of the inner barrel is divided into a first conduit and a second conduit by a partition, the side wall of the first conduit of the inner barrel is provided with two first openings corresponded to the ball collection opening and the water outlet respectively, and a ball and water separating network is installed in the first conduit to prevent rubber balls from flowing into the first opening correspond to the water outlet, the side wall of the second conduit of the inner barrel is provided with two second openings corresponded to the ball sending opening and the water inlet respectively, and another ball and water separating network is installed in the second conduit to prevent rubber balls from flowing into the other second opening corresponded to the water inlet, the inner barrel is connected to an inner barrel rotating driver which is able to drive the inner barrel to rotate in the outer barrel so that two first openings can aim at the ball collection opening and the water outlet respectively and two second openings can aim at the ball sending opening and the water inlet respectively.

Preferably, the outer barrel and the inner barrel share the same axis, the ends of the inner barrel and sliding bearings embedded in each ends of the outer barrel form a revolute pairs. There is a gap between the outer barrel and inner barrel, and some collecting rings are embedded into the ball collection opening, the water outlet, the ball sending opening and the water inlet respectively, one end of the connecting ring is a flat opening, and the other end is a saddle-shaped opening which is closely placed against the outside surface of the inner barrel, with these collecting rings, the ball collection opening, the water outlet, the ball sending opening and the water inlet of the outer barrel are interconnected with four openings of the inner barrel respectively.

Preferably, a seal ring is disposed next to each pair two opposite saddle-shaped openings, the seal ring is closely placed against the inner side wall of the outer barrel to control the least leaking of liquid.

Preferably, the axes of the ball collection opening and the water outlet on one side wall of the outer barrel are located at the same radial plane of the outer barrel; The axes of two first openings on one side wall of the inner barrel of the first conduit are located at the same radial plane of the inner barrel; The axes of the ball sending opening and the water inlet on the other side wall of the outer barrel are located at the same radial plane of the outer barrel; The axes of two second openings on one side wall of the inner barrel of the second conduit are located at the same radial plane of the inner barrel.

Preferably, the axes of the water outlet and the water inlet are located at the same line; The axes of one first opening and one second opening are located at the same line; The axes of the ball sending opening and the ball collection opening are located at the same line; The axes of the other first opening and the other second opening are located at the same line.

Preferably, the outer barrel can be installed horizontally or at a tilt angle of less than or equal to 90 degrees with the horizontal plane.

Preferably, the partition is fixed in the inner barrel.

Preferably, One end of the outer barrel is provided with a sight glass opening with a glass installed; a seal body is disposed between the glass and the end of the partition near the sight glass opening.

The inner barrel rotating driver could be an electric actuator, a pneumatic actuator or a hydraulic actuator.

### Beneficial Effect

The beneficial effect of present disclosure compared with traditional technology is that, rubber balls and water enter the first conduit from the ball collection opening, then water passes through the water outlet to flow out for collecting balls, and water enters the second conduit from the water inlet, then brings balls out from the ball sending opening for sending balls. The separator collects balls when it sends balls because the first conduit and the second conduit are designed independently and work separately, it can promote the collecting efficiency that consumes less power, and its structure is simple and reliable and easy to make. The separator is appropriate for end-covered cleaning machines, double-return-pipe cleaning machines and single-return-pipe cleaning machines.

### BRIEF DESCRIPTION OF THE DRAWINGS

FIG. 1 is a first schematic view of the horizontal collecting-while-sending-ball water separator provided by the present disclosure;

FIG. 2 is a second schematic view of the horizontal collecting-while-sending-ball water separator provided by the present disclosure;

FIG. 3 is a cross-sectional view of the horizontal collecting-while-sending-ball water separator provided by the present disclosure;

FIG. 4 is a schematic view of the inner barrel of the horizontal collecting-while-sending-ball water separator provided by the present disclosure;

FIG. 5 is a schematic view of the connecting ring of the horizontal collecting-while-sending-ball water separator provided by the present disclosure;

FIG. 6 is a schematic view of the seal ring of the horizontal collecting-while-sending-ball water separator provided by the present disclosure;

FIG. 7 is a schematic view of the seal strip of the horizontal collecting-while-sending-ball water separator provided by the present disclosure;

FIG. 8 is a schematic view of the horizontal collecting-while-sending-ball water separator provided by the present disclosure used in an end-covered cleaning machine;

FIG. 9 is a schematic view of the horizontal collecting-while-sending-ball water separator provided by the present disclosure used in a double-return-pipe cleaning machine;

FIG. 10 is a schematic view of the horizontal collecting-while-sending-ball water separator provided by the present disclosure used in a single-return-pipe cleaning machine.

### DETAILED DESCRIPTION

A detailed description with preferred embodiments is provided according to the drawings.

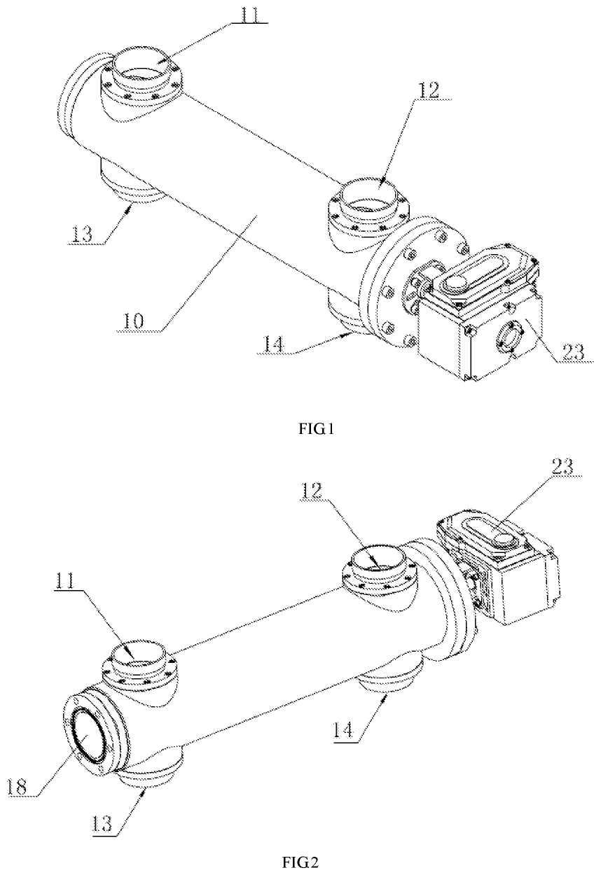

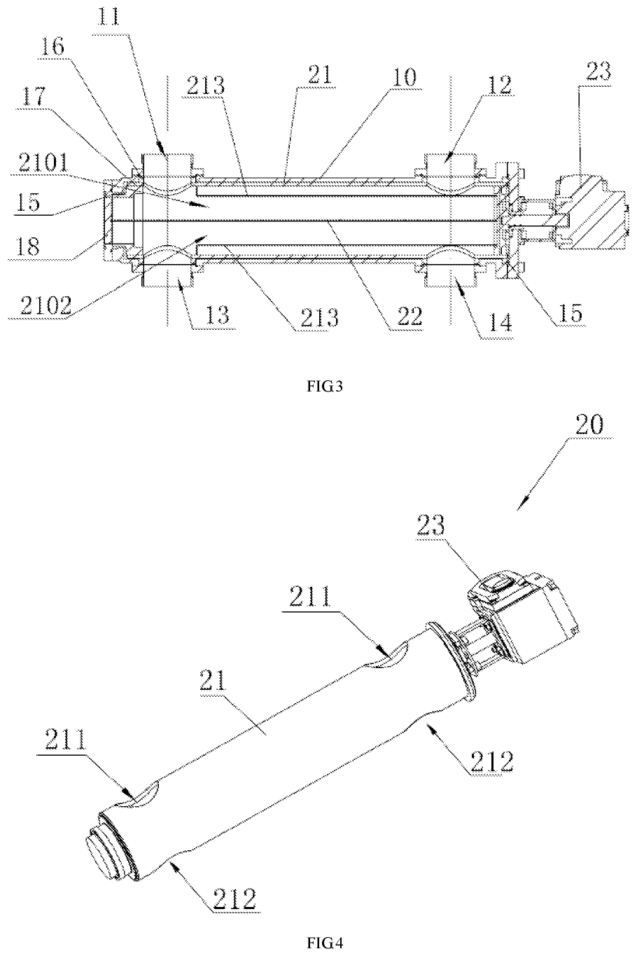

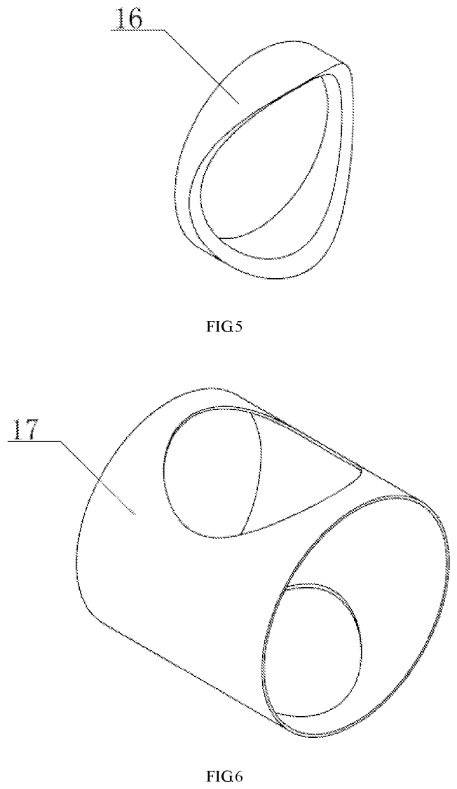

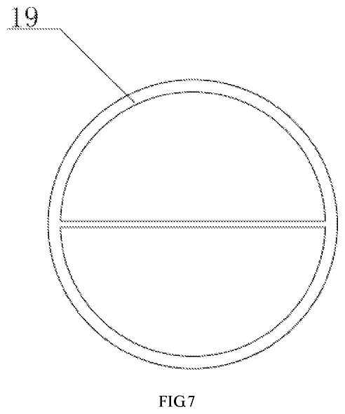

A preferred embodiment of the present disclosure is provided as shown in FIGS. 1 to 7. The horizontal collecting-while-sending-ball water separator comprises an outer barrel 10, on one side wall of the outer barrel 10 is provided with a ball collection opening 11 and a water outlet 12, and the other side wall of the outer barrel 10 is provided with a ball sending opening 13 and a water inlet 14; Both the water outlet 12 and the water inlet 14 are connected with a water inlet and outlet control valve 20 for turning on and off of water, and the control valve 20 comprises an inner barrel 21 that is configured inside the outer barrel 10, and the inner space of the inner barrel 21 is divided into a first conduit 2101 and a second conduit 2102 by a partition 22, the side wall of the first conduit is provided with two first openings 211 corresponded to the ball collection opening and the water outlet respectively, and a ball and water separating network 213 is installed in the first conduit to prevent rubber balls from entering the first opening the one corresponded to the water outlet, the side wall of the second conduit is provided with two second openings 212 corresponded to the ball sending opening and the water inlet respectively, and another ball and water separating network 213 is installed in the second conduit to prevent rubber balls from entering the second openings 212 the one corresponded to the water inlet, the inner barrel is connected to an inner barrel rotating driver 23 which is able to drive the inner barrel to rotate in the outer barrel so that two first openings can aim at the ball sending opening and the water inlet respectively and two second openings can aim at the ball collection opening and the water outlet respectively, thus rubber balls and water pass through the collection opening 11 and the corresponded first opening 211 to enter the first conduit 2101, then water pass through the other first opening 211 and the water outlet 12 to flow out when collecting balls, and water pass through the water inlet 14 and the corresponded second opening 212 to enter the second conduit 2102 to take rubber balls out from the other second opening 212 and the ball sending opening 13, the first conduit 2101 and the second conduit 2102 are independent of each other so as to send and collect balls synchronously, not only does this result in a higher collecting efficiency that consumes less power, but also allows the structure of the separator to be more simple and reliable and easy to make; After a balls collection and sending process, rotating inner barrel 21 by the inner barrel rotating driver 23 to let the two first openings 211 aim at the water inlet 14 and the ball sending opening 13 respectively, and the two second openings 212 aim at the water outlet 12 and the ball collection opening 11 respectively to prepare for the next process. The outer barrel 10 can be installed horizontally to make the central axis of the outer barrel flushed with horizontal plane, and it also can be installed at a tilt angle of less than or equal to 90 degrees with the horizontal plane. The inner barrel rotating driver 23 could be an electric actuator controlled by PLC or a single chip, it also could be a pneumatic actuator or a hydraulic actuator.

The outer barrel 10 and the inner barrel 21 share the same axis, and both ends of the outer barrel 10 are provided with sliding bearings 15, the sliding bearings 15 and the ends of the inner barrel form a revolute pair so that the inner barrel 21 can rotate in the outer barrel 10 by the inner barrel rotating driver 23.

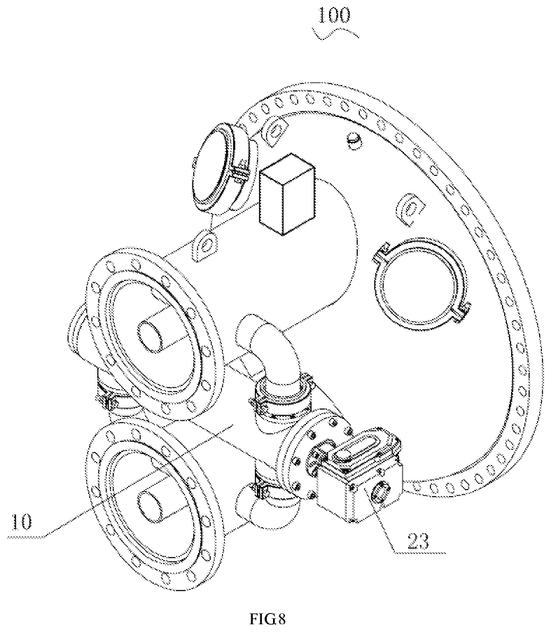

Please refer to FIG. 6 and FIG. 7, there is a gap between the outer barrel and inner barrel to make sure that the inner barrel rotates smoothly in the outer barrel. Some collecting rings 16 are embedded into the ball collection opening″, the water outlet 12, the ball sending opening 13 and the water inlet 14 respectively, one end of the collecting ring 16 is flat, and the other end is a saddle-shaped surface which is closely placed against the outside surface of the inner barrel, with these collecting rings, the ball collection opening, the water outlet, the ball sending opening and the water inlet of the outer barrel are interconnected with four openings of the inner barrel, so that it has a sealing effect to prevent liquid from flowing out and the mixing of water in the ball sending conduit and the ball collecting conduit, and won't affect the rotation of the inner barrel 21. each saddle-shaped opening rim is provided with a seal ring 17, the seal ring 17 is closely placed against the inner side wall of the outer barrel to control the least leaking of liquid and prevent the mixing of water in the ball sending conduit and the ball collecting conduit.

The partition 22 is fixed in the inner barrel 21 by such as welding, or the partition 22 is mounted movably by methods such as inserting or clamping. The partition 22 divides the inner barrel 20 equally into a first conduit 2101 and a second conduit 2102.

The axes of the ball collection opening 11 and water outlet 12 on one side wall of the outer barrel 10 are located at the same radial plane of the outer barrel 10; The axes of the ball sending opening 13 and the water inlet 14 on the other side wall of the outer barrel 10 are located at the same radial plane of the outer barrel 10; that is, the ball collection opening 11 and water outlet 12 are disposed in layers on one radial plane, and the ball sending opening 13 and the water inlet 14 are disposed in layers on the other radial plane; accordingly, The axes of two first openings 211 on one side wall of the first conduit 2101 of the inner barrel are located at the same radial plane of the inner barrel 21; The axes of two second openings 212 on one side wall of the second conduit 2102 of the inner barrel are located at the same radial plane of the inner barrel 21, that is, two first openings 211 are disposed in layers on one radial plane, and two second openings 212 are disposed in layers on the other.

As a best embodiment, the symmetrical water outlet 12 and water inlet 14 share the same axes; The axes of one first opening 211 and one second opening 212 are located at the same line; The axes of the symmetrical ball sending opening 13 and ball collection opening 11 are located at the same line; The axes of the other first opening 211 and the other second opening 212 are located at the same line, that is, The axes of four openings of the outer barrel 10 are located at the same radial plane and the openings on opposite side walls of the outer barrel 10 are disposed symmetrically, accordingly, the axes of four openings of the inner barrel 21 are located at the same radial plane and the first openings 211 and the second opening 212 on opposite side walls of the inner barrel 21 are disposed symmetrically, in this way, two first openings 211 correspond to the ball collection opening 11 and the water outlet 12 respectively, and two second openings 212 correspond to the ball sending opening 13 and the water inlet 14 respectively to realize collecting-while-sending-ball actions; While inner barrel rotating driver 23 drives the inner barrel 21 to rotate 90 degrees, four openings of the outer barrel 10 don't correspond to the four openings of the inner barrel 21, and while inner barrel rotating driver 23 drives the inner barrel 21 to rotate 180 degrees, two first openings 211 aim at the ball sending opening 13 and the water inlet 14 respectively, and two second openings 212 aim at the ball collection opening 11 and the water outlet 12 respectively, the separator can start the collecting-while-sending-ball actions again. Furthermore, as another preferred embodiment, the diameters of the four opening of the outer barrel 10 and the four opening of the inner barrel 21 are the same.

One end of the outer barrel 10 is provided with a sight glass opening 18 with a glass installed for observing the status of the collecting-and-sending-ball and adding or fetching balls; One end of the inner barrel 10 is sealed, the other end is open, and the open end is connected to the sight glass opening 18, a seal body 19 is disposed between the glass and the end of the partition to prevent liquid leaking out when outer barrel rotates.

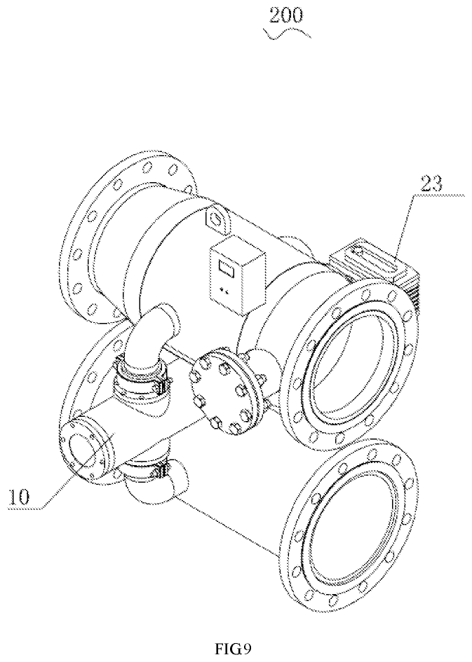

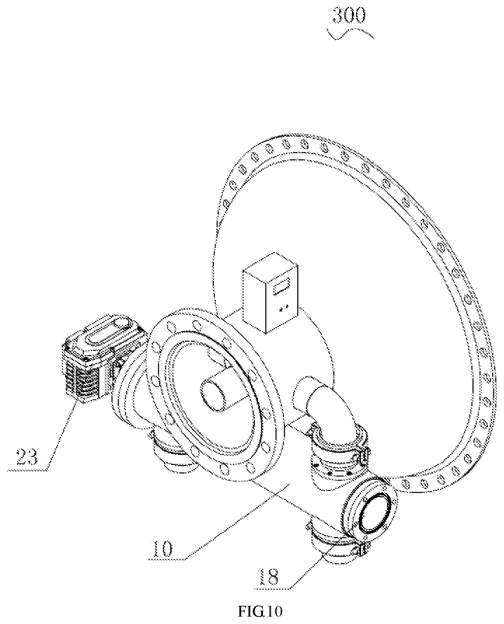

The horizontal ball water separator is applied in an end-covered cleaning machine as illustrated in FIG. 8, and it is also can be applied in a double-return-pipe cleaning machine as illustrated in FIG. 9, or can be applied in a single-return-pipe cleaning machine as illustrated in FIG. 10 to clean condensers, evaporators or air conditioning units.

Here is how it works: the inner barrel rotating driver 23 drives the inner barrel 21 to rotate to the 0-degree position, two second openings 212 of the inner barrel 21 aim at the ball sending opening 13 and the water inlet 14 respectively and two first openings 211 aim at the ball collection opening 11 and the water outlet 12 respectively; The collecting and sending-ball actions can start at the same time, when water passes through the water inlet 14 and the corresponding second openings 212, and flows into the second conduit 2102, brings rubber balls to flow out from the ball sending opening 13 and the corresponding second openings 212; when rubber balls and water pass through the ball collection opening 11 and the corresponding first opening 211, and flow into the first conduit 2101, then rubber balls stay in the first conduit 2101 but water flows out from the water outlet 12 and the corresponding first opening 211; After a process of collecting-while-sending-ball, the inner barrel rotating driver 23 drives the inner barrel 21 to rotate 90 degrees, so that four openings of the outer barrel 10 and the four openings of the inner barrel 21 are mutually staggered, users can open the sight glass opening to add rubber ball if necessary; when the inner barrel rotating driver 23 drives the inner barrel 21 to rotate 180 degrees, two first openings 211 of the inner barrel 21 direct at the ball sending opening 13 and the water inlet 14 respectively, and two second openings 212 direct at the ball collection opening 11 and the water outlet 12 respectively, that is, the location of the first conduit 2101 and the second conduit 2102 of the inner barrel 21 is exchanged, balls collected in previous process act as sending balls in next process, which is more convenient.

In summary, the technical solution of the present disclosure can fully and effectively achieve the above-mentioned purpose of the invention, and the structure and functional principles of the present invention have been fully described in the embodiments, and can achieve the expected effect and purpose without departing from the original Under the premise of the principle and essence of the invention, various changes or modifications can be made to the embodiments of the invention. Therefore, the present disclosure includes all replacements within the scope of the patent application, and any equivalent changes made within the scope of the patent application for the present disclosure fall within the scope of the patent application for this case.

What is claimed is:

1. A horizontal collecting-while-sending-ball water separator comprising an outer barrel, one side wall of the outer barrel having a ball collection opening and a water outlet, the other side wall of the outer barrel having a ball collection opening and a water inlet;
a water inlet and outlet control valve for turning on and off of water connecting to the water outlet and the water inlet, the control valve comprising an inner barrel configured inside the outer barrel, the inner space of the inner barrel is divided into a first conduit and a second conduit by a partition, the side wall of the first conduit of the inner barrel having two first openings corresponded to the ball collection opening and the water outlet respectively, a ball and water separating network is installed in the first conduit to prevent rubber balls from flowing to the first opening corresponded to the water outlet, the side wall of the second conduit of the inner barrel having two second openings corresponded to the ball collection opening and the water inlet respectively, and another ball and water separating network is installed in the second conduit to prevent rubber balls from flowing to the other second opening corresponded to the water inlet;
an inner barrel rotating driver connecting to the inner barrel for driving the inner barrel to rotate in the outer barrel to make two first openings aim at the ball collection opening and the water outlet respectively and two second openings aim at the ball collection opening and the water inlet respectively.

2. The horizontal collecting-while-sending-ball water separator according to claim 1, wherein the outer barrel and the inner barrel having the same axis, the ends of the inner barrel and sliding bearings embedded in each ends of the outer barrel forming a revolute pairs; a gap is disposed between the outer barrel and inner barrel, collecting rings are embedded into the ball collection opening, the water outlet, the ball collection opening and the water inlet respectively for connecting the ball collection opening, the water outlet, the ball collection opening and the water inlet of outer barrel with four openings of the inner barrel respectively, one end of the connecting ring is a flat opening, and the other end is a saddle-shaped opening placed closely against the outside surface of the inner barrel.

3. The horizontal collecting-while-sending-ball water separator according to claim 1, wherein a seal ring is disposed around saddle-shaped openings and the seal ring is closely placed against the inner side wall of the outer barrel.

4. The horizontal collecting-while-sending-ball water separator according to claim 1, wherein the axes of the ball collection opening and the water outlet on one side wall of the outer barrel are located at the same radial plane of the outer barrel; the axes of two first openings on one side wall of the first conduit of the inner barrel are located at the same radial plane of the inner barrel; the axes of the ball sending opening and the water inlet on the other side wall of the outer barrel are located at the same radial plane of the outer barrel; the axes of two second openings on one side wall of the second conduit of the inner barrel are located at the same radial plane of the inner barrel.

5. The horizontal collecting-while-sending-ball water separator according to claim 1, wherein he axes of the water outlet and the water inlet are located at the same line; The axes of one first opening and one second opening are located at the same line; the axes of the ball sending opening and the ball collection opening are located at the same line; the axes of the other first opening and the other second opening are located at the same line.

6. The horizontal collecting-while-sending-ball water separator according to claim 1, wherein the outer barrel is installed horizontally or at a tilt angle of less than or equal to 90 degrees.

7. The horizontal collecting-while-sending-ball water separator according to claim 1, wherein the partition is fixed in the inner barrel.

8. The horizontal collecting-while-sending-ball water separator according to claim 1, wherein one end of the outer barrel is provided with a sight glass opening with a glass installed, a seal body is disposed on the end of the partition near the sight glass opening to fit tightly against the glass.

9. The horizontal collecting-while-sending-ball water separator according to claim 1, wherein the inner barrel rotating driver is an electric actuator, a pneumatic actuator or a hydraulic actuator.
